(19) United States
(12) Patent Application Publication
(10) Pub. No.: US 2001/0042155 A1
(43) Pub. Date: Nov. 15, 2001

(54) INSTRUCTION MEMORY CIRCUIT

(75) Inventor: HIROSHI NAMEKI, KANAGAWA (JP)

Correspondence Address: SUGHRUE MION ZINN MACPEAK & SEAS, 2100 PENNSYLVANIA AVENUE NW, WASHINGTON, DC, 20037

(73) Assignee: NEC CORPORATION

(21) Appl. No.: 09/235,308

(22) Filed: Jan. 22, 1999

(30) Foreign Application Priority Data
Jan. 22, 1998 (JP) 10507/1998

(51) Int. Cl. G06F 15/00; G06F 12/00; G06F 13/00

(52) U.S. Cl. 711/100

(57) ABSTRACT

An instruction memory circuit comprises an external instruction memory for storing a plurality of instruction codes, and an internal instruction memory having capability of outputting and rewriting instruction codes stored therein at high speed for storing instruction codes which have preliminarily been read out from the external instruction memory and outputting the instruction codes for instruction execution. The internal instruction memory is composed of 1st through Nth memory blocks which can be accessed independently. The instruction memory circuit also comprises a memory block reading measure and a memory block writing measure. The memory block reading measure activates one of the 1st through Nth memory blocks for instruction code reading, and executes instruction code reading from the activated memory block. The memory block writing measure activates another one of the 1st through Nth memory blocks for instruction code writing during execution of the instruction code reading by the memory block reading measure, and executes instruction code writing into the activated memory block. By such operation, “instruction code reading (execution) from a memory block” and “instruction code writing into another memory block” can be executed simultaneously, and thus high speed and efficient instruction execution can be realized.

### BACKGROUND OF THE INVENTION

The present invention relates to an instruction memory circuit, and in particular, to an instruction memory circuit which is utilized as writable instruction memory for a digital signal processor etc.

Description of the Prior Art

Instruction memory circuits have been widely used as writable instruction memory for digital signal processors etc., as shown in “NEC Data Book, Signal Processing LSI (DSP/Voice)”, NEC Corporation, pages 317-318 (January 1996) (hereafter, referred to as “document No.1”), for example.

FIG. 1 is a block diagram showing a conventional instruction memory circuit which is described in the document No.1. The conventional instruction memory circuit of FIG. 1 is composed of a DSP (Digital Signal Processor) 10 and an external instruction memory 8. The DSP 10 comprises an internal instruction memory 101, a program counter 1, an instruction fetch address generation circuit 2, selectors 3, 6 and 14, an OR circuit 4, a latch 5, an instruction decoder 7, and 3-state buffers 12 and 13.

The internal instruction memory 101 reads out an instruction code DI from its memory cells that are designated by an internal instruction address AI, according to control of an internal instruction memory read signal RI, and stores an instruction code DE which has been read out from the external instruction memory 8 into its memory cells that are designated by an internal instruction address AI, according to control of an instruction write signal W.

The program counter 1 outputs an instruction address AP, the internal instruction memory read signal RI, a memory selection signal SM, and an external instruction memory read control signal RP.

The instruction fetch address generation circuit 2 outputs an instruction fetch address AW, the instruction write signal W, and an external instruction memory fetch control signal R, according to an instruction fetch instruction CW which is supplied from outside.

The selector 3 makes a selection from the instruction fetch address AW and the instruction address AP according to control of the instruction write signal W, and outputs the selected address to the external instruction memory 8 as an external instruction address AE.

The OR circuit 4 takes logical OR between the external instruction memory read control signal RP and the external instruction memory fetch control signal R, and thereby outputs an external instruction memory read signal RE.

The latch 5 latches the instruction code DE which has been read out from the external instruction memory 8 and outputs a latched instruction code DL.

The selector 6 makes a selection from the instruction code DI which has been read out from the internal instruction memory 101 and the latched instruction code DL from the external instruction memory 8 according to control of the memory selection signal SM, and outputs the selected instruction code DS to the instruction decoder 7.

The instruction decoder 7 decodes the selected instruction code DS and executes the decoded instruction.

The external instruction memory 8, which is provided outside the DSP 10, reads out the instruction code DE from its memory cells that are designated by the external instruction address AE, according to control of the external instruction memory read signal RE.

The 3-state buffer 12 controls output of the instruction code DI from the internal instruction memory 101, according to control of the internal instruction memory read signal RI.

The 3-state buffer 13 controls input of the instruction code DE to the internal instruction memory 101, according to control of the instruction write signal W.

The selector 14 makes a selection from the instruction fetch address AW and the instruction address AP according to control of the instruction write signal W, and supplies the selected address to the internal instruction memory 101 as the internal instruction address AI.

In the following, the operation of the conventional instruction memory circuit of FIG. 1 will be described referring to FIG. 1 and FIG. 2. FIG. 2 is a timing chart showing an example of the operation of the conventional instruction memory circuit of FIG. 1. In this type of instruction memory circuits, large memory is usually used for the external instruction memory 8, and thus the processing speed of the external instruction memory 8 is far slower than that of the internal instruction memory 101. Therefore, the external instruction memory 8 uses a clock signal CKE whose clock cycle is twice the clock cycle of a clock signal CKI which is used by the internal instruction memory 101.

First, instruction code reading from the internal instruction memory 101 (i.e. instruction execution from the internal instruction memory 101) will be explained. The program counter 1 activates the internal instruction memory read signal RI, and thereby puts the internal instruction memory 101 into reading mode and activates the 3-state buffer 12. Meanwhile, the selector 14 selects the instruction address AP since the instruction write signal W supplied from the instruction fetch address generation circuit 2 is inactive, and supplies the instruction address AP to the internal instruction memory 101 as the internal instruction address AI. The internal instruction memory 101 outputs an instruction code DI that is designated by the internal instruction address AI (the instruction address AP) to the selector 6 via the activated 3-state buffer 12. The selector 6 selects the instruction code DI as the selected instruction code DS according to control of the memory selection signal SM, and supplies the selected instruction code DS (the instruction code DI) to the instruction decoder 7. The instruction decoder 7 decodes the selected instruction code DS (the instruction code DI) and executes the decoded instruction.

Next, instruction code writing into the internal instruction memory 101 will be explained. The instruction fetch address generation circuit 2 activates the instruction write signal W according to the instruction fetch instruction CW which is supplied from outside, and thereby puts the internal instruction memory 101 into writing mode and activates the 3-state buffer 13. The instruction fetch address generation circuit 2 also outputs the instruction fetch address AW. The selector 14 selects the instruction fetch address AW from the instruction fetch address generation circuit 2 since the instruction write signal W is active, and supplies the instruction fetch address AW to the internal instruction memory 101 as the internal instruction address AI. Meanwhile, the selector 3 also selects the instruction fetch address AW and supplies the instruction fetch address AW to the external instruction memory 8 as the external instruction address AE. The external instruction memory 8 outputs an instruction code DE that is designated by the external instruction address AE (the instruction fetch address AW). The internal instruction memory 101 receives the instruction code DE via the activated 3-state buffer 13, and stores (writes) the instruction code DE into its memory cells that correspond to the instruction fetch address AW.

Next, instruction code reading from the external instruction memory 8 (i.e. instruction execution from the external instruction memory 8) will be explained. In the “instruction code reading from the external instruction memory 8”, the external instruction memory read control signal RP outputted by the program counter 1 is active, and the external instruction memory fetch control signal R outputted by the instruction fetch address generation circuit 2 is inactive. The signals RP and R are supplied to the OR circuit 4. The OR circuit 4 takes logical OR between the external instruction memory read control signal RP and the external instruction memory fetch control signal R and thereby outputs the external instruction memory read signal RE of a high level. By the high level external instruction memory read signal RE, the external instruction memory 8 is put into reading mode. Meanwhile, the selector 3 selects the instruction address AP from the program counter 1 as the external instruction address AE since the instruction write signal W is inactive, and supplies the external instruction address AE (the instruction address AP) to the external instruction memory 8. The external instruction memory 8 reads out and outputs an instruction code DE that is designated by the instruction address AP. The instruction code DE outputted by the external instruction memory 8 is latched by the latch 5. The selector 6 selects the latched instruction code DL from the latch 5 as the selected instruction code DS according to control of the memory selection signal SM, and supplies the selected instruction code DS (the latched instruction code DL) to the instruction decoder 7. The instruction decoder 7 decodes the selected instruction code DS (the instruction code DE) and executes the decoded instruction.

Generally, instruction codes which are required high speed execution are stored in the internal instruction memory 101 and executed, and instruction codes which are not required high speed execution are stored in the external instruction memory 8 and executed, by the operations which have been described above.

However, in the conventional instruction memory circuit which has been described above, the “instruction code reading from the internal instruction memory 101 (that is, execution of an instruction code DI read out from the internal instruction memory 101)” and the “instruction code writing into the internal instruction memory 101” can not be executed simultaneously. Therefore, during the internal instruction memory 101 is rewritten, it is impossible to read out an instruction code DI from the internal instruction memory 101 and execute the instruction code DI. It is of course possible to read out an instruction code DE from the external instruction memory 8 and execute the instruction code DE in such a situation, however, such instruction execution out of the slow external instruction memory 8 takes longer than instruction execution out of the fast internal instruction memory 101.

On the other hand, it is also possible to reduce frequency of access to the slow external instruction memory 8 and realize faster instruction execution, by increasing storage capacity of the fast internal instruction memory 101. However, such an internal instruction memory 101 having capability of high speed operation needs larger area per memory cell and larger power consumption per memory cell. Therefore, increasing storage capacity of the internal instruction memory 101 causes considerably larger power consumption (due to increase in power consumption per memory cell and frequent high speed access to the internal instruction memory 101) and larger chip size of the whole instruction memory circuit.

### SUMMARY OF THE INVENTION

It is therefore the primary object of the present invention to provide an instruction memory circuit, by which high speed and efficient instruction access, which is especially required of digital signal processors, can be realized, along with avoiding increase of power consumption and chip size.

In accordance with a first aspect of the present invention, there is provided an instruction memory circuit comprising an external instruction memory for storing a plurality of instruction codes and an internal instruction memory having capability of outputting and rewriting instruction codes stored therein at high speed for storing instruction codes which have preliminarily been read out from the external instruction memory and outputting the instruction codes for instruction execution. The internal instruction memory is composed of 1st through Nth memory blocks (N: integer larger than 1) which can be accessed independently.

In accordance with a second aspect of the present invention, in the first aspect, the instruction memory circuit further comprises a memory block reading means and a memory block writing means. The memory block reading means activates one of the 1st through Nth memory blocks for instruction code reading and executes instruction code reading from the activated memory block. The memory block writing means activates another one of the 1st through Nth memory blocks for instruction code writing during execution of the instruction code reading by the memory block reading means, and executes instruction code writing into the activated memory block.

In accordance with a third aspect of the present invention, in the first aspect, the instruction memory circuit further comprises a program counter, an instruction fetch address generation circuit, a first selector, a second selector, 1st through Nth output switching means, 1st through Nth input switching means, and 1st through Nth address selectors. The program counter outputs an instruction address (AP), N internal instruction memory read signals (RI1 through RIN) for activating each of the 1st through Nth memory blocks of the internal instruction memory respectively for instruction code reading, a memory selection signal (SM), and an external instruction memory read control signal (RP) for putting the external instruction memory into reading mode. The instruction fetch address generation circuit outputs an instruction fetch address (AW), N instruction write signals (W1 through WN) for activating each of the 1st through Nth memory blocks of the internal instruction memory respectively for instruction code writing, and an external instruction memory fetch control signal (R) for putting the external instruction memory 8 into reading mode. The first selector makes a selection from the instruction fetch address (AW) and the instruction address (AP) according to the N instruction write signals (W1 through WN) supplied from the instruction fetch address generation circuit and outputs the selected address to the external instruction memory as an external instruction address (AE). The second selector makes a selection from an instruction code (DI) which has been read out from the internal instruction memory and an instruction code (DE) which has been read out from the external instruction memory according to control of the memory selection signal (SM) supplied from the program counter and outputs the selected instruction code (DS) to an instruction decoder. Each of the 1st through Nth output switching means controls output of the instruction code (DI) from corresponding one of the 1st through Nth memory blocks, according to control of corresponding one of the N internal instruction memory read signals (RI1 through RIN) supplied from the program counter. Each of the 1st through Nth input switching means controls input of the instruction code (DE) to corresponding one of the 1st through Nth memory blocks, according to control of corresponding one of the N instruction write signals (W1 through WN) supplied from the instruction fetch address generation circuit. Each of the 1st through Nth address selectors makes a selection from the instruction fetch address (AW) and the instruction address (AP) according to control of corresponding one of the N instruction write signals (W1 through WN) supplied from the instruction fetch address generation circuit and supplies the selected address to corresponding one of the 1st through Nth memory blocks as an internal instruction address (AI).

In accordance with a fourth aspect of the present invention, in the third aspect, each of the 1st through Nth output switching means includes a 3-state buffer which is activated by corresponding one of the N internal instruction memory read signals (RI1 through RIN), and each of the 1st through Nth input switching means includes a 3-state buffer which is activated by corresponding one of the N instruction write signals (W1 through WN).

In accordance with a fifth aspect of the present invention, in the third aspect, the instruction memory circuit further comprises a latch for latching the instruction code (DE) which has been read out from the external instruction memory and outputting a latched instruction code (DL) to the second selector.

In accordance with a sixth aspect of the present invention, in the third aspect, the instruction memory circuit further comprises a logical circuit which outputs a signal (RE) for putting the external instruction memory into reading mode when either the external instruction memory read control signal (RP) or the external instruction memory fetch control signal (R) is active.

In accordance with a seventh aspect of the present invention, in the third aspect, the instruction memory circuit further comprises an instruction fetch control register which includes instruction code fetch request bits, memory block designation bits, and instruction fetch address bits. The instruction code fetch request bits store a value which indicates whether or not a request for instruction code writing has been supplied from outside, and supply the value to the instruction fetch address generation circuit. The memory block designation bits store a value which indicates a memory block that has been designated for the instruction code writing, and supply the value to the instruction fetch address generation circuit. And the instruction fetch address bits store a value which indicates the instruction fetch address (AW), and supply the value to the instruction fetch address generation circuit.

### BRIEF DESCRIPTION OF THE DRAWINGS

The objects and features of the present invention will become more apparent from the consideration of the following detailed description taken in conjunction with the accompanying drawings, in which:

FIG. 1 is a block diagram showing a conventional instruction memory circuit;

FIG. 2 is a timing chart showing an example of the operation of the conventional instruction memory circuit of FIG. 1;

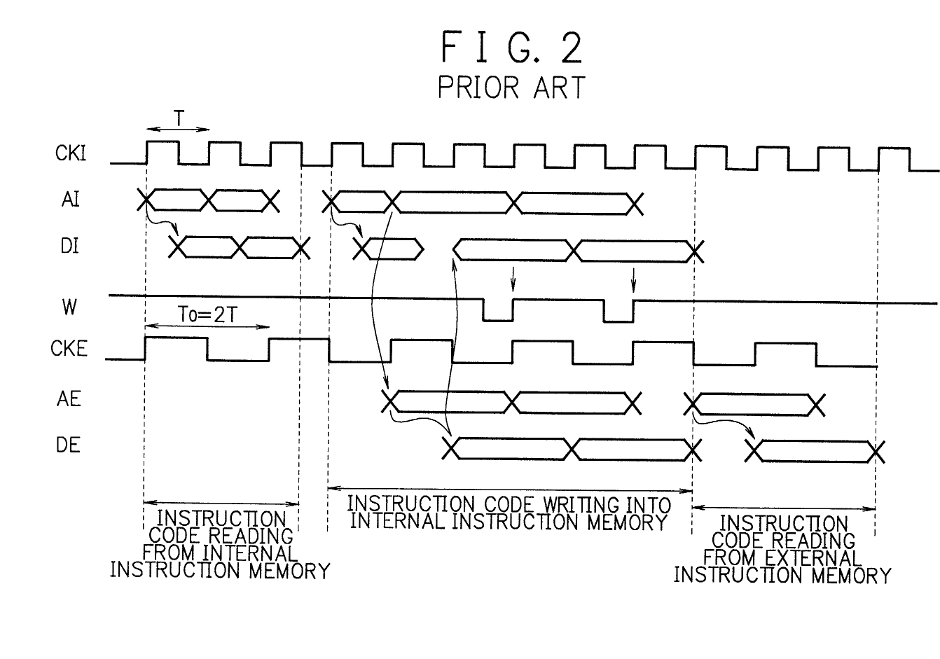

FIG. 3 is a block diagram showing an instruction memory circuit according to a first embodiment of the present invention;

FIG. 4 is a timing chart showing an example of the operation of the instruction memory circuit of FIG. 3;

FIG. 5 is a schematic diagram showing usage statuses of memory blocks in an internal instruction memory of the instruction memory circuit of FIG. 3; and

FIG. 6 is a block diagram showing an instruction memory circuit according to a second embodiment of the present invention.

### DESCRIPTION OF THE PREFERRED EMBODIMENTS

Referring now to the drawings, a description will be given in detail of preferred embodiments in accordance with the present invention.

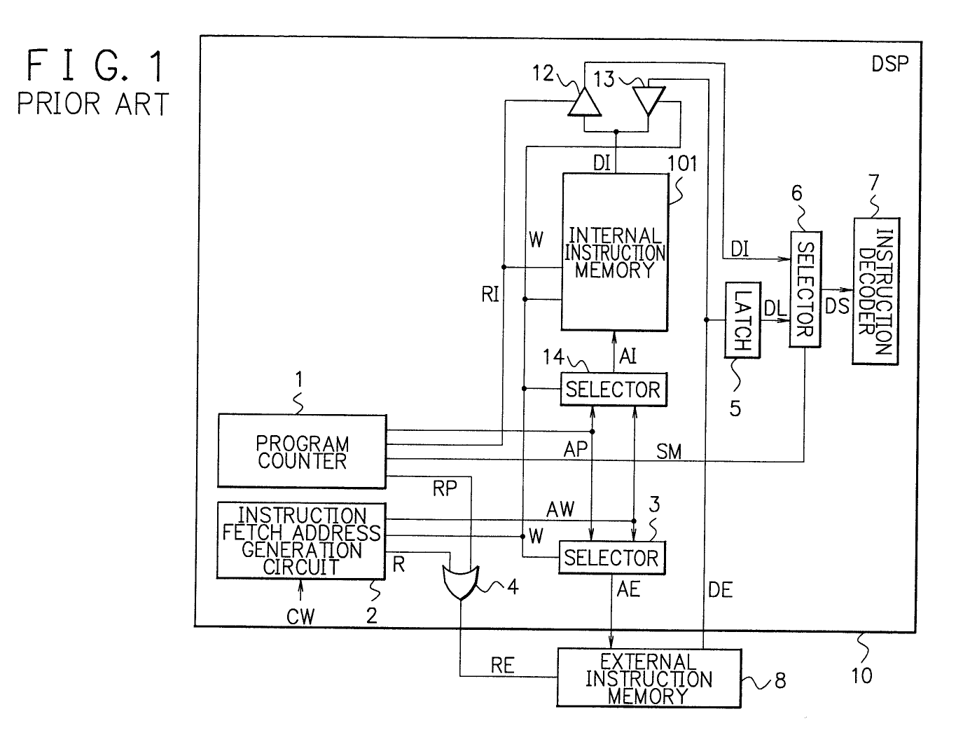

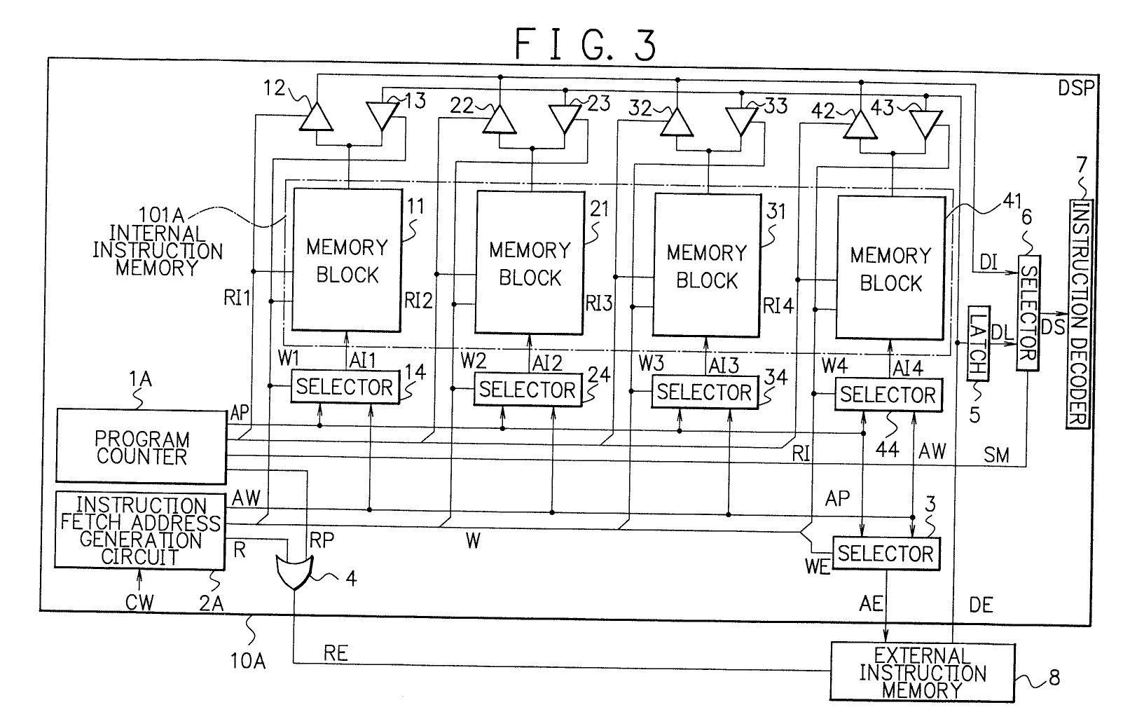

FIG. 3 is a block diagram showing an instruction memory circuit according to a first embodiment of the present invention. The instruction memory circuit of FIG. 3 is composed of a DSP (Digital Signal Processor) 10A and an external instruction memory 8. The DSP 10A comprises selectors 3, 6 and 14, an OR circuit 4, a latch 5, an instruction decoder 7, and 3-state buffers 12 and 13, in the same way as the DSP 10 of the conventional instruction memory circuit of FIG. 1. The above components of the DSP 10A are basically the same as those of the DSP 10 of the conventional instruction memory circuit of FIG. 1.

The DSP 10A of FIG. 3 further comprises an internal instruction memory 101A, a program counter 1A, an instruction fetch address generation circuit 2A, 3-state buffers 22, 23, 32, 33, 42 and 43, and selectors 24, 34 and 44. The internal instruction memory 101A and the external instruction memory 8 are realized by, for example, SRAM (Static Random Access Memory).

The internal instruction memory 101A is provided with memory blocks 11, 21, 31 and 41 having the same storage capacities. The memory blocks 11, 21, 31 and 41 are supplied with internal instruction memory read signals RI1, RI2, RI3 and RI4 respectively from the program counter 1A, and one of the memory blocks 11, 21, 31 and 41 that is supplied with the internal instruction memory read signal RI1, RI2, RI3 or RI4 is activated for instruction code reading. The memory blocks 11, 21, 31 and 41 are also supplied with internal instruction addresses AI1, AI2, AI3 and AI4 from the selectors 14, 24, 34 and 44, respectively. The internal instruction memory 101A reads out an instruction code DI from memory cells (that are designated by one of the internal instruction addresses AI1, AI2, AI3 and AI4) in one of the memory blocks 11, 21, 31 and 41 (that is activated by one of the internal instruction memory read signals RI1, RI2, RI3 and RI4).

The memory blocks 11, 21, 31 and 41 are also supplied with instruction write signals W1, W2, W3 and W4 respectively from the instruction fetch address generation circuit 2A, and one of the memory blocks 11, 21, 31 and 41 that is supplied with the instruction write signal W1, W2, W3 or W4 is activated for instruction code writing. The internal instruction memory 101A stores an instruction code DE which has been read out from the external instruction memory 8 into its memory cells (that are designated by one of the internal instruction addresses AI1, AI2, AI3 and AI4) in one of the memory blocks 11, 21, 31 and 41 (that is activated by one of the instruction write signals W1, W2, W3 and W4).

The program counter 1A outputs an instruction address AP, the internal instruction memory read signals RI1, RI2, RI3 and RI4 (also referred to as an “internal instruction memory read signal RI”), a memory selection signal SM, and an external instruction memory read control signal RP.

The instruction fetch address generation circuit 2A outputs an instruction fetch address AW, the instruction write signals W1, W2, W3 and W4 (also referred to as an “instruction write signal W”), and an external instruction memory fetch control signal R, according to an instruction fetch instruction CW which is supplied from outside.

The selector 3 makes a selection from the instruction fetch address AW and the instruction address AP according to control of an instruction write signal WE, and outputs the selected address to the external instruction memory 8 as an external instruction address AE. Here, the instruction write signal WE is a signal which becomes active when one or more of the instruction write signals W1, W2, W3 and W4 are active. The selector 3 selects the instruction fetch address AW if the instruction write signal WE is active, and selects the instruction address AP if the instruction write signal WE is inactive.

The OR circuit 4 takes logical OR between the external instruction memory read control signal RP and the external instruction memory fetch control signal R, and thereby outputs an external instruction memory read signal RE.

The latch 5 latches the instruction code DE which has been read out from the external instruction memory 8 and outputs a latched instruction code DL.

The selector 6 makes a selection from the instruction code DI which has been read out from the internal instruction memory 101A and the latched instruction code DL from the external instruction memory 8 according to control of the memory selection signal SM, and outputs the selected instruction code DS to the instruction decoder 7.

The instruction decoder 7 decodes the selected instruction code DS and executes the decoded instruction.

The external instruction memory 8, which is provided outside the DSP 10A, reads out the instruction code DE from its memory cells that are designated by the external instruction address AE, according to control of the external instruction memory read signal RE.

The 3-state buffer 12 controls output of the instruction code DI from the memory block 11 of the internal instruction memory 101A, according to control of the internal instruction memory read signal RI1.

The 3-state buffer 13 controls input of the instruction code DE to the memory block 11 of the internal instruction memory 101A, according to control of the instruction write signal W1.

The selector 14 makes a selection from the instruction fetch address AW and the instruction address AP according to control of the instruction write signal W1, and supplies the selected address to the memory block 11 of the internal instruction memory 101A as the internal instruction address AI1.

The 3-state buffers 22 and 23 and the selector 24 are provided in order to control input and output of the memory block 21 of the internal instruction memory 101A, and operate similarly to the 3-state buffers 12 and 13 and the selector 14 according to control of the internal instruction memory read signal RI2 and the instruction write signal W2.

The 3-state buffers 32 and 33 and the selector 34 are provided in order to control input and output of the memory block 31 of the internal instruction memory 101A, and operate similarly to the 3-state buffers 12 and 13 and the selector 14 according to control of the internal instruction memory read signal RI3 and the instruction write signal W3.

The 3-state buffers 42 and 43 and the selector 44 are provided in order to control input and output of the memory block 41 of the internal instruction memory 101A, and operate similarly to the 3-state buffers 12 and 13 and the selector 14 according to control of the internal instruction memory read signal RI4 and the instruction write signal W4.

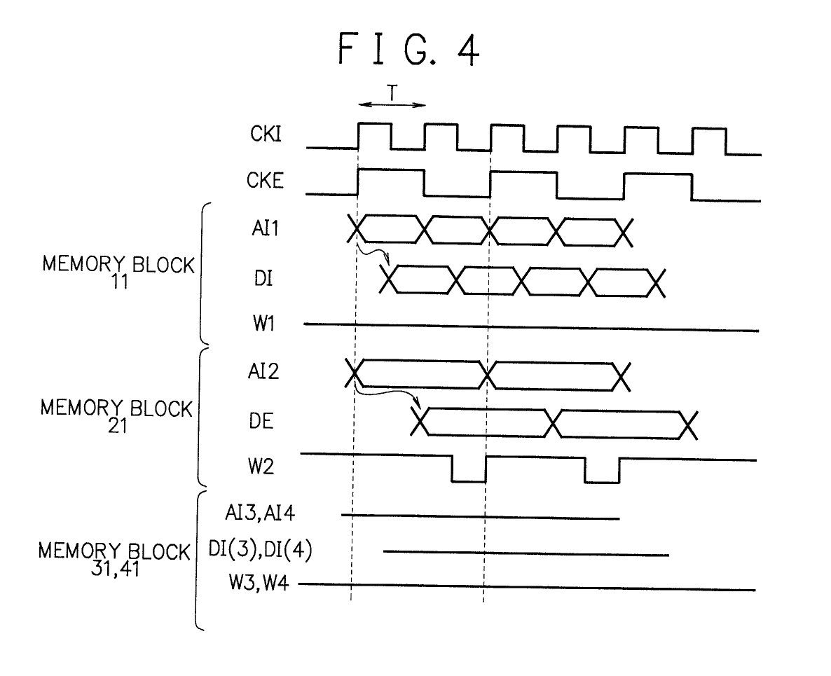

In the following, the operation of the instruction memory circuit of FIG. 3 will be described referring to FIG. 3 and FIG. 4. FIG. 4 is a timing chart showing an example of the operation of the instruction memory circuit of FIG. 3.

First, instruction code reading from a memory block of the internal instruction memory 101A (i.e. instruction execution from a memory block of the internal instruction memory 101A) will be explained. The “instruction code reading from a memory block” in this embodiment is executed similarly to the “instruction code reading from the internal instruction memory 101” in the conventional instruction memory circuit of FIG. 1. In the following, instruction code reading from the memory block 11 will be explained, for example. The program counter 1A activates the internal instruction memory read signal RI1, and thereby puts the memory block 11 of the internal instruction memory 101A into reading mode and activates the 3-state buffer 12. Meanwhile, the selector 14 selects the instruction address AP since the instruction write signal W1 supplied from the instruction fetch address generation circuit 2A is inactive, and supplies the instruction address AP to the memory block 11 as the internal instruction address AI1. The memory block 11 outputs an instruction code DI that is designated by the internal instruction address AI1 (the instruction address AP) to the selector 6 via the activated 3-state buffer 12. The selector 6 selects the instruction code DI as the selected instruction code DS according to control of the memory selection signal SM, and supplies the selected instruction code DS (the instruction code DI) to the instruction decoder 7. The instruction decoder 7 decodes the selected instruction code DS (the instruction code DI) and executes the decoded instruction.

Next, instruction code writing into a memory block of the internal instruction memory 101A will be explained. The “instruction code writing into a memory block” in this embodiment is executed similarly to the “instruction code writing into the internal instruction memory 101” in the conventional instruction memory circuit of FIG. 1. In the following, instruction code writing into the memory block 41 will be explained, for example. The instruction fetch address generation circuit 2A activates the instruction write signal W4 according to the instruction fetch instruction CW which is supplied from outside, and thereby puts the memory block 41 into writing mode and activates the 3-state buffer 43. The instruction fetch address generation circuit 2A also outputs the instruction fetch address AW. The selector 44 selects the instruction fetch address AW from the instruction fetch address generation circuit 2A since the instruction write signal W4 is active, and supplies the instruction fetch address AW to the memory block 41 as the internal instruction address AI4. Meanwhile, the selector 3 also selects the instruction fetch address AW since the instruction write signal WE is active, and supplies the instruction fetch address AW to the external instruction memory 8 as the external instruction address AE. The external instruction memory 8 outputs an instruction code DE that is designated by the external instruction address AE (the instruction fetch address AW). The internal memory block 41 receives the instruction code DE via the activated 3-state buffer 43, and stores (writes) the instruction code DE into its memory cells that correspond to the instruction fetch address AW.

The instruction code writing into a memory block of the internal instruction memory 101A which has been described above can be executed according to two methods, for example.

In a first method, the instruction code writing is executed to a whole memory block. The instruction fetch address generation circuit 2A first outputs an initial value of the instruction fetch address AW (“XX000” in hexadecimal notation, for example) that corresponds to the starting address (i.e. the lowest address) of a memory block, and thereafter successively increments the instruction fetch address AW by a predetermined number, till the whole memory block is rewritten. Incidentally, when an instruction fetch address AW “XX000” is outputted by the instruction fetch address generation circuit 2A, an instruction code DE that has been stored at an address “XX000” of the external instruction memory 8 is read out, and the instruction code DE is stored at an address “000” (the lower 3 digits of the instruction fetch address AW, for example) of the memory block that is designated (activated) by the instruction write signal W1, W2, W3 or W4 which is outputted by the instruction fetch address generation circuit 2A.

In a second method, the instruction code writing is executed for one instruction code. The instruction fetch address generation circuit 2A outputs an instruction fetch address AW (“XX3D4” in hexadecimal notation, for example), thereby an instruction code DE that has been stored at an address “XX3D4” of the external instruction memory 8 is read out, and the instruction code DE is stored at an address “3D4” (the lower 3 digits of the instruction fetch address AW, for example) of the memory block that is designated (activated) by the instruction write signal W1, W2, W3 or W4.

Next, instruction code reading from the external instruction memory 8 (i.e. instruction execution from the external instruction memory 8) will be explained. The “instruction code reading from the external instruction memory 8” in this embodiment is executed basically in the same way as the “instruction code reading from the external instruction memory 8” in the conventional instruction memory circuit of FIG. 1. In the “instruction code reading from the external instruction memory 8”, the external instruction memory read control signal RP outputted by the program counter 1A is active, and the external instruction memory fetch control signal R outputted by the instruction fetch address generation circuit 2A is inactive. The signals RP and R are supplied to the OR circuit 4. The OR circuit 4 takes logical OR between the external instruction memory read control signal RP and the external instruction memory fetch control signal R and thereby outputs the external instruction memory read signal RE of a high level. By the high level external instruction memory read signal RE, the external instruction memory 8 is put into reading mode. Meanwhile, the selector 3 selects the instruction address AP from the program counter 1A as the external instruction address AE since the instruction write signal WE is inactive, and supplies the external instruction address AE (the instruction address AP) to the external instruction memory 8. The external instruction memory 8 reads out and outputs an instruction code DE that is designated by the instruction address AP. The instruction code DE outputted by the external instruction memory 8 is latched by the latch 5. The selector 6 selects the latched instruction code DL from the latch 5 as the selected instruction code DS according to control of the memory selection signal SM, and supplies the selected instruction code DS (the latched instruction code DL) to the instruction decoder 7. The instruction decoder 7 decodes the selected instruction code DS (the instruction code DE) and executes the decoded instruction.

Next, simultaneous execution of “instruction code reading from the memory block 11 of the internal instruction memory 101A” and “instruction code writing into the memory block 21 of the internal instruction memory 101A” will be explained, for example. The program counter 1A activates the internal instruction memory read signal RI1 corresponding to the memory block 11, and thereby puts the memory block 11 into reading mode and activates the 3-state buffer 12. Meanwhile, the instruction fetch address generation circuit 2A activates the instruction write signal W2 corresponding to the memory block 21, according to the instruction fetch instruction CW which is supplied from outside, and thereby puts the memory block 21 into writing mode and activates the 3-state buffer 23.

The selector 14 selects the instruction address AP since the instruction write signal W1 supplied from the instruction fetch address generation circuit 2A is inactive, and supplies the instruction address AP to the memory block 11 as the internal instruction address AI1. The memory block 11 outputs an instruction code DI that is designated by the internal instruction address AI1 (the instruction address AP) to the selector 6 via the activated 3-state buffer 12. The selector 6 selects the instruction code DI as the selected instruction code DS according to control of the memory selection signal SM, and supplies the selected instruction code DS (the instruction code DI) to the instruction decoder 7. The instruction decoder 7 decodes the selected instruction code DS (the instruction code DI) and executes the decoded instruction.

The selector 24 selects the instruction fetch address AW which is supplied from the instruction fetch address generation circuit 2A since the instruction write signal W2 is active, and supplies the instruction fetch address AW to the memory block 21 as the internal instruction address AI2. Meanwhile, the selector 3 also selects the instruction fetch address AW since the instruction write signal WE is active, and supplies the instruction fetch address AW to the external instruction memory 8 as the external instruction address AE. The external instruction memory 8 outputs an instruction code DE that is designated by the external instruction address AE (the instruction fetch address AW). The memory block 21 receives the instruction code DE via the activated 3-state buffer 23, and stores (writes) the instruction code DE into its memory cells that correspond to the instruction fetch address AW.

In the simultaneous execution of “instruction code reading from the memory block 11 of the internal instruction memory 101A” and “instruction code writing into the memory block 21 of the internal instruction memory 101A” which has been described above, the memory blocks 31 and 41 are both inactive, since the internal instruction memory read signals RI3 and RI4 and the instruction write signals W3 and W4 are all inactive.

Simultaneous execution of “instruction code reading from a memory block MBx (MBx: 11, 21, 31 or 41)” and “instruction code writing into a memory block MBy (MBy: 11, 21, 31 or 41)” is also executed similarly to the above explanation, as long as the memory block MBx is different from the memory block MBy.

In this embodiment, the external instruction memory 8 uses a clock signal CKE whose clock cycle is twice the clock cycle of a clock signal CKI which is used by the internal instruction memory 101A, in the same way as the conventional instruction memory circuit. Therefore, instruction code reading from the external instruction memory 8 takes twice the time which is needed for instruction code reading from the memory block 11, 21, 31 or 41 of the internal instruction memory 101A.

As mentioned before, in the conventional instruction memory circuit of FIG. 1, it was impossible to execute the “instruction code reading from the internal instruction memory 101 (i.e., execution of an instruction code DI read out from the internal instruction memory 101)” and the “instruction code writing into the internal instruction memory 101” simultaneously. However, referring again to FIG. 4, the “instruction code reading from the memory block 11 (i.e., execution of an instruction code DI read out from the memory block 11)” and the “instruction code writing into the memory block 21” can be executed simultaneously in the instruction memory circuit of this embodiment.

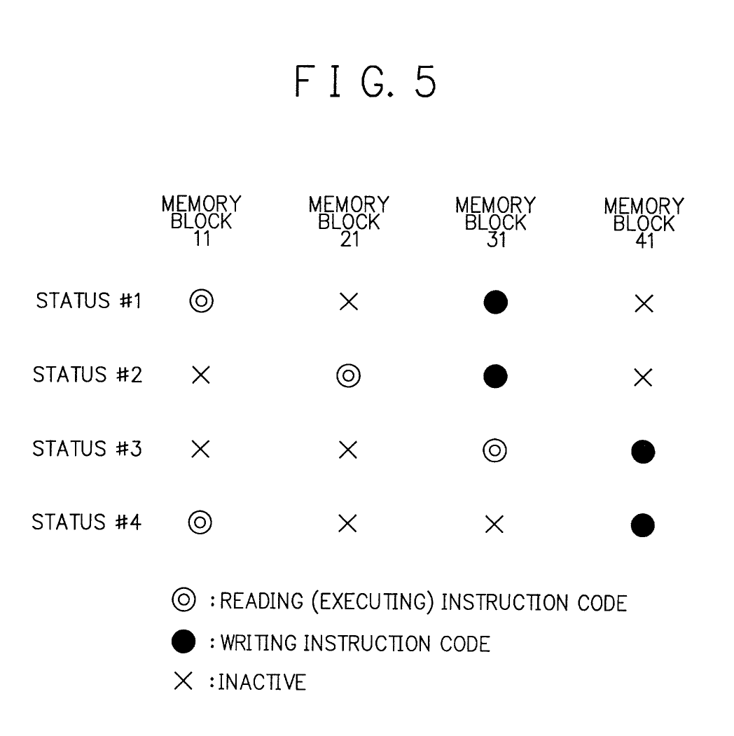

FIG. 5 is a schematic diagram showing usage statuses of the memory blocks 11, 21, 31 and 41 of the internal instruction memory 101A. Referring to FIG. 5, the status #1 shows that “instruction code reading from the memory block 11 (i.e. instruction execution from the memory block 11)” can be executed simultaneously with “instruction code writing into the memory block 31”, and the status #2 shows that “instruction code reading from the memory block 21 (i.e. instruction execution from the memory block 21)” can be executed simultaneously with “instruction code writing into the memory block 31”, and the status #3 shows that “instruction code reading from the memory block 31 (i.e. instruction execution from the memory block 31)” can be executed simultaneously with “instruction code writing into the memory block 41”, and the status #4 shows that “instruction code reading from the memory block 11 (i.e. instruction execution from the memory block 11)” can be executed simultaneously with “instruction code writing into the memory block 41”, for example. The sequence of the statuses #1 through #4 shown in FIG. 5 is an example of the operation of the memory blocks in the internal instruction memory 101A. In the statuses #1 through #4, the total number of memory blocks is 16, and the number of activated memory blocks is 8. Therefore, power consumption of the internal instruction memory 101A can be reduced to 50%, in comparison with the internal instruction memory 101 of the conventional instruction memory circuit. In generalized expression, when the internal instruction memory is partitioned into n (n: 2, 3, 4, . . . ) memory blocks, power consumption is reduced to 2/n in comparison with the conventional instruction memory circuit.

As described above, in the instruction memory circuit according to the first embodiment of the present invention, “instruction code reading from a memory block (i.e. execution of an instruction code DI read out from the memory block)” and “instruction code writing into another memory block” can be executed simultaneously, therefore, efficiency and speed of program execution can be increased.

Further, power consumption can be reduced by activating memory blocks which are necessary for instruction code reading or instruction code writing and setting the other memory blocks inactive.

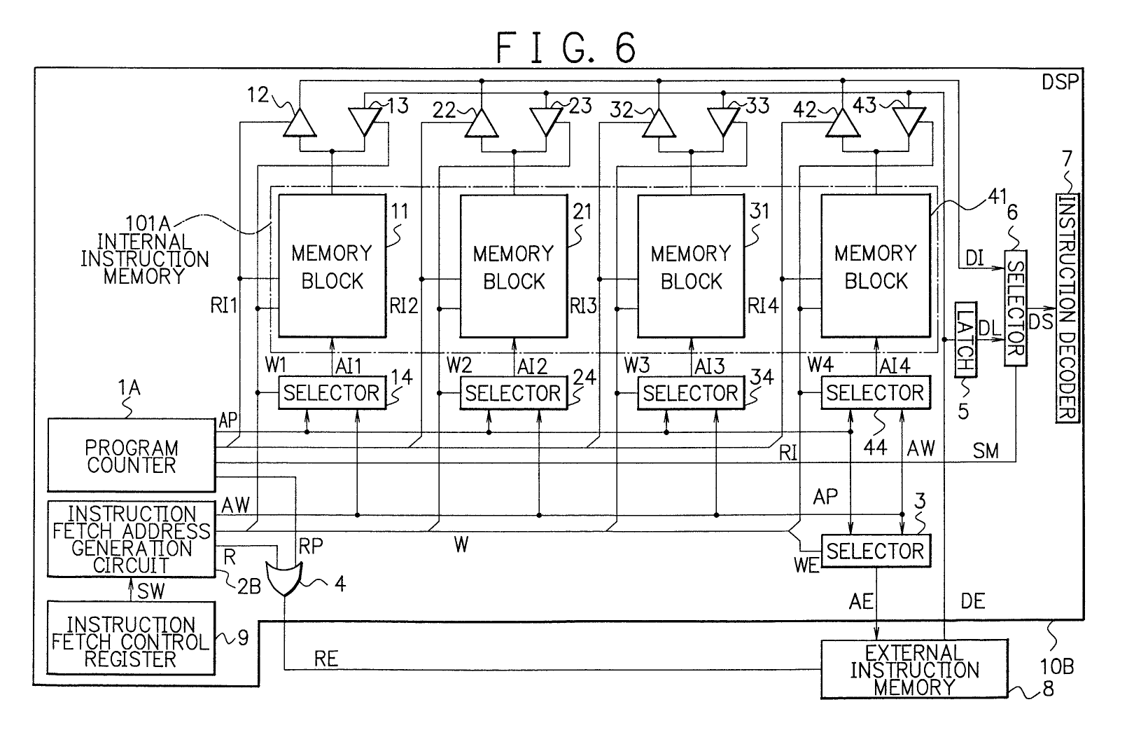

FIG. 6 is a block diagram showing an instruction memory circuit according to a second embodiment of the present invention. The instruction memory circuit of FIG. 6 is composed of a DSP (Digital Signal Processor) 10B and an external instruction memory 8. The DSP 10B of the second embodiment is almost the same as the DSP 10A of the first embodiment, except that the DSP 10B further comprises an instruction fetch control register 9.

The instruction fetch control register 9 includes instruction code fetch request bits, memory block designation bits, and instruction fetch address bits. The instruction code fetch request bits store a value which indicates whether or not a request for instruction code writing has been supplied from outside. The memory block designation bits store a value which indicates a memory block that has been designated (selected) for the instruction code writing. The instruction fetch address bits store a value which indicates the instruction fetch address AW. The instruction code fetch request bits, memory block designation bits, and instruction fetch address bits of the instruction fetch control register 9 are directly rewritten by signals which are supplied from outside, and the values stored therein are supplied to the instruction fetch address generation circuit 2B shown in FIG. 6 as an instruction fetch control signal SW. Thereafter, the instruction fetch address generation circuit 2B of the second embodiment operates in the same way as the instruction fetch address generation circuit 2A of the first embodiment.

As set forth hereinabove, in the instruction memory circuit according to the embodiments of the present invention, the internal instruction memory 101A is provided with a plurality of memory blocks which can be accessed independently, therefore, “instruction code reading from a memory block (i.e. execution of an instruction code DI read out from the memory block)” and “instruction code writing into another memory block” can be executed simultaneously. Therefore, frequency of instruction execution from the internal instruction memory 101A can be considerably increased, and it is also possible to let every instruction code be executed from the high speed internal instruction memory 101A. Thus, high speed and efficient instruction execution (program execution) can be realized.

Further, power consumption can be reduced by partitioning the internal instruction memory 101A into small memory blocks and activating memory blocks which are necessary for instruction code reading or instruction code writing and setting the other memory blocks inactive.

Furthermore, by partitioning the internal instruction memory 101A into memory blocks so as to have the same storage capacities, address assignment to the memory blocks and addressing can be simplified. Control of the memory blocks can be executed simply without needing a complex address decoder, and thus increase of chip size can be avoided.

While the present invention has been described with reference to the particular illustrative embodiments, it is not to be restricted by those embodiments but only by the appended claims. For example, the number of memory blocks in the internal instruction memory is not limited to 4, and the number can be varied appropriately as long as it is larger than 1. It is to be appreciated that those skilled in the art can change or modify the embodiments without departing from the scope and spirit of the present invention.

What is claimed is:

1. An instruction memory circuit comprising:
an external instruction memory for storing a plurality of instruction codes; and
an internal instruction memory having capability of outputting and rewriting instruction codes stored therein at high speed, for storing instruction codes which have preliminarily been read out from the external instruction memory and outputting the instruction codes for instruction execution, wherein;
the internal instruction memory is composed of 1st through Nth memory blocks (N: integer larger than 1) which can be accessed independently.

2. An instruction memory circuit as claimed in claim 1, further comprising:
a memory block reading means for activating one of the 1st through Nth memory blocks for instruction code reading and executing instruction code reading from the activated memory block; and
a memory block writing means for activating another one of the 1st through Nth memory blocks for instruction code writing during execution of the instruction code reading by the memory block reading means, and executing instruction code writing into the activated memory block.

3. An instruction memory circuit as claimed in claim 1, further comprising:
a program counter which outputs an instruction address (AP), N internal instruction memory read signals (RI1 through RIN) for activating each of the 1st through Nth memory blocks of the internal instruction memory respectively for instruction code reading, a memory selection signal (SM), and an external instruction memory read control signal (RP) for putting the external instruction memory into reading mode;
an instruction fetch address generation circuit which outputs an instruction fetch address (AW), N instruction write signals (W1 through WN) for activating each of the 1st through Nth memory blocks of the internal instruction memory respectively for instruction code writing, and an external instruction memory fetch control signal (R) for putting the external instruction memory 8 into reading mode;
a first selector which makes a selection from the instruction fetch address (AW) and the instruction address (AP) according to the N instruction write signals (W1 through WN) supplied from the instruction fetch address generation circuit and outputs the selected address to the external instruction memory as an external instruction address (AE);
a second selector which makes a selection from an instruction code (DI) which has been read out from the internal instruction memory and an instruction code (DE) which has been read out from the external instruction memory according to control of the memory selection signal (SM) supplied from the program counter and outputs the selected instruction code (DS) to an instruction decoder;
1st through Nth output switching means each of which controls output of the instruction code (DI) from corresponding one of the 1st through Nth memory blocks, according to control of corresponding one of the N internal instruction memory read signals (RI1 through RIN) supplied from the program counter;
1st through Nth input switching means each of which controls input of the instruction code (DE) to corresponding one of the 1st through Nth memory blocks, according to control of corresponding one of the N instruction write signals (W1 through WN) supplied from the instruction fetch address generation circuit; and
1st through Nth address selectors each of which makes a selection from the instruction fetch address (AW) and the instruction address (AP) according to control of corresponding one of the N instruction write signals (W1 through WN) supplied from the instruction fetch address generation circuit and supplies the selected address to corresponding one of the 1st through Nth memory blocks as an internal instruction address (AI).

4. An instruction memory circuit as claimed in claim 3, wherein each of the 1st through Nth output switching means includes a 3-state buffer which is activated by corresponding one of the N internal instruction memory read signals (RI1 through RIN), and each of the 1st through Nth input switching means includes a 3-state buffer which is activated by corresponding one of the N instruction write signals (W1 through WN).

5. An instruction memory circuit as claimed in claim 3, further comprising a latch for latching the instruction code (DE) which has been read out from the external instruction memory and outputting a latched instruction code (DL) to the second selector.

6. An instruction memory circuit as claimed in claim 3, further comprising a logical circuit which outputs a signal (RE) for putting the external instruction memory into reading mode when either the external instruction memory read control signal (RP) or the external instruction memory fetch control signal (R) is active.

7. An instruction memory circuit as claimed in claim 3, further comprising an instruction fetch control register which includes:
instruction code fetch request bits for storing a value which indicates whether or not a request for instruction code writing has been supplied from outside, and supplying the value to the instruction fetch address generation circuit;
memory block designation bits for storing a value which indicates a memory block that has been designated for the instruction code writing, and supplying the value to the instruction fetch address generation circuit; and
instruction fetch address bits for storing a value which indicates the instruction fetch address (AW), and supplying the value to the instruction fetch address generation circuit.
